(19) United States
(12) Patent Application Publication
(10) Pub. No.: US 2011/0315744 A1
(43) Pub. Date: Dec. 29, 2011

(54) METHOD FOR MAKING A METAL CONNECTING ROD REINFORCED WITH LONG FIBERS

(75) Inventors: Richard Masson, Les Loges en Josas (FR); Patrick Dunleavy, Palaiseau (FR)

(73) Assignee: Messier-Bugatti-Dowty, Velizy Villacoublay (FR)

(21) Appl. No.: 13/141,946

(22) PCT Filed: Dec. 18, 2009
(86) PCT No.: PCT/FR09/01452

§ 371 Date: Sep. 8, 2011

(30) Foreign Application Priority Data
Dec. 24, 2008 (FR) 08 07451

(51) Int. Cl. B23K 31/02; B23K 20/12

(52) U.S. Cl. 228/112.1

(57) ABSTRACT

The invention relates to a method of fabricating a connecting rod, the method including: fabricating a body (1) of metallic material reinforced by long fibers (5) oriented mainly along a longitudinal axis (X) of the body; fabricating an endpiece out of a metallic material reinforced by short fibers; and welding the endpiece to the end of the body using a friction-mixing welding technique.

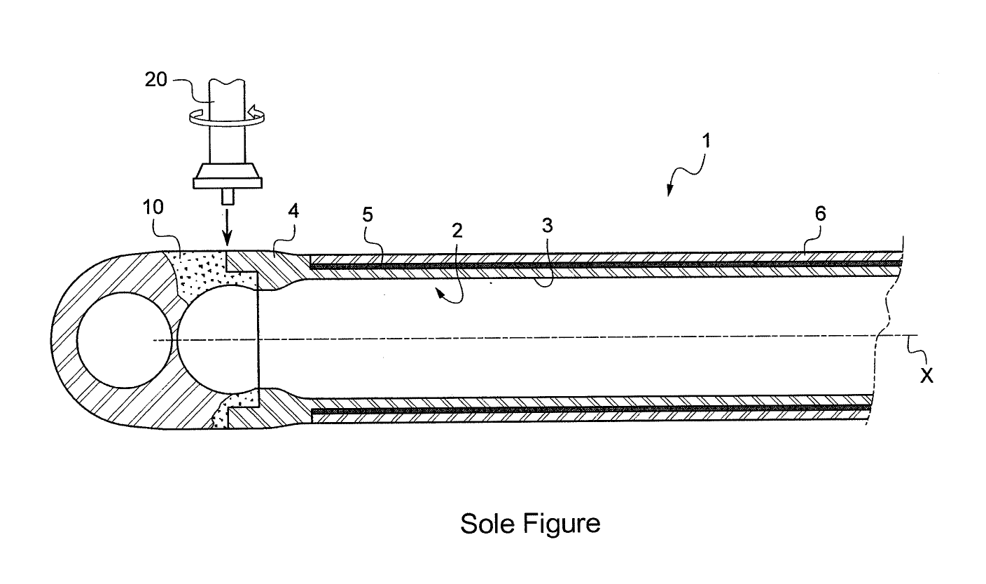

The present invention relates to a method of fabricating a connecting rod of metal reinforced by long fibers.

### TECHNOLOGICAL BACKGROUND

It is known to reinforce the body of a connecting rod by means of long fibers extending along the axis of the body. For example, document FR 2 502 036 discloses a connecting rod in which the body includes a core made of long fibers. The fibers are grouped together to form a bundle that is subjected to diffusion of copper. The bundle of fibers as stiffened in this way is subsequently incorporated in a mold in order to form the central core of a molded connecting rod, e.g. made of aluminum. Such reinforcement provides very good performance, since it extends along the stress axis of the connecting rod.

In contrast, incorporating long fibers in or around endpieces of the connecting rod is technically more difficult, and turns out not to be as effective as reinforcing the body, in so far as certain long fibers incorporated in this way in such endpieces are subjected to forces that extend perpendicularly to their long direction.

Thus, in the above-mentioned document, the endpieces of the connecting rod are made of metal only, and they do not benefit from the reinforcement of the long fibers. The endpieces are thus made of a uniform material that is suitable for withstanding the stresses to which the ends are subjected and the deformations that they induce.

OBJECT OF THE INVENTION

An object of the invention is to provide a method of fabricating a connecting rod having a body that is reinforced with long fibers, the method providing a certain amount of continuity between the body and the endpieces of the connecting rod.

### BRIEF DESCRIPTION OF THE INVENTION The invention provides a method of fabricating a connecting rod, the method comprising the steps of:

fabricating a body of metallic material reinforced by long fibers oriented mainly along a longitudinal axis of the body;
fabricating an endpiece out of a metallic material reinforced by short fibers; and
welding the endpiece to the end of the body using a friction-mixing welding technique.

Long fibers are particularly advantageous for reinforcing the body, whereas short fibers enable the endpiece to be reinforced significantly while conserving a generally uniform nature for the material that constitutes it. The recommended welding technique, also known as “friction stir welding”, provides intimate bonding between the body and the endpiece, creating a progressive transition between a zone with short fibers and a zone with long fibers.

By means of the provisions of the invention, it is thus possible to form a connecting rod that is reinforced in all of its portions, by using fibers of a length that is appropriate for each of the zones of the connecting rod, while also presenting continuity between the zones.

### BRIEF DESCRIPTION OF THE FIGURE

The invention can be better understood in the light of the following description of the sole FIGURE, which is a diagrammatic section view of a connecting rod in a particular embodiment of the invention, shown during fabrication.

### DETAILED DESCRIPTION OF THE INVENTION

With reference to the FIGURE, the connecting rod comprises a body 1, with a main portion thereof being visible in the FIGURE. The body comprises a sleeve 2 that, in this example, is made out of high-strength aluminum. The sleeve 2 has a main portion 3 that is cylindrical and that is terminated by a collar 4. A sheet of long fibers 5 is placed on the outside face of the main portion 3, the fibers in this example being silicon carbide fibers that extend parallel to a longitudinal axis X of the body. The sleeve 2 is preferably molded and the long fibers 5 are inserted in the mold, thereby enabling the metal to infiltrate between the fibers, thus ensuring a high degree of cohesion between the sleeve 2 and the long fibers 5. It is also possible to use ceramic fibers coated in a metal sheath placed as a sheet around a cylindrical or conical blank, and then subjecting the assembly to hot compacting. Other methods of achieving cohesion between the fibers and the sleeve may be implemented, for example adhesive or the use of synthetic resins.

In this example, the long fibers 5 are covered in a cylindrical cover 6, serving to protect the fibers. It should be observed that the long fibers extend up to the vicinity of the collar 4.

An endpiece 10 is also fabricated, here an endpiece in the form of an eyelet, being made of aluminum reinforced with short fibers, e.g. fibers of silicon carbide. The endpiece includes a collar 11 complementary to the collar 4 of the body 1. The presence of short fibers in the material of the endpiece 10 is shown symbolically in the FIGURE.

The endpiece 10 is fitted to the body, and the two elements are welded together, via the interface between the collars, using the friction-mixing welding technique. It is recalled that this technique makes use of a specific tool 20 that is set into rapid rotation and that rubs against the two elements that are to be assembled together. The friction of the tool against the elements softens the materials thereof, which enters into a pasty phase. The tool then penetrates into the join plane, at the interface between the parts that are to be welded together, and it intimately mixes together the materials of the two elements by a combined operation of forging and extruding the metal.

Such welding gives rise to local mixing of the material of the endpiece 10 in the material of the sleeve 2, such that the short reinforcing fibers present in the material of the endpiece 10 defuse locally into the material of the sleeve 2, thereby providing continuity between those two elements.

Naturally, the other endpiece needs to be assembled to the other end of the sleeve, using the same operations.

This provides a connecting rod in which the body is reinforced by long fibers, and the endpiece is reinforced by short fibers, with the transitions between the short fiber zones and the long-fiber zones being progressive.

The invention is not limited by the above description, but encompasses any variant within the ambit defined by the claims.

In particular, although the metals mentioned above are high-strength aluminums, e.g. of the 7000 series, the invention applies to a body and to endpieces made of other metallic materials, such as titanium or magnesium.

The metallic material of the sleeve may itself contain short fibers that are compatible with the short fibers of the endpiece.

Finally, although it is stated that the body of the connecting rod is fabricated entirely before welding on the endpieces, it is possible for the endpieces to be welded to the sleeve before the sleeve receives long-fiber reinforcement.

1. A method of fabricating a connecting rod, the method comprising the steps of:
fabricating a body (1) of metallic material reinforced by long fibers (5) oriented mainly along a longitudinal axis (X) of the body;
fabricating an endpiece out of a metallic material reinforced by short fibers; and
welding the endpiece to the end of the body using a friction-mixing welding technique.

2. A method according to claim 1, wherein the body comprises a sleeve (2) terminated by a collar (4), and further comprises a cylindrical main portion (3) carrying the long fibers (5).

3. A method according to claim 2, wherein the main portion of the sleeve (2) is covered by a cylindrical cover (6).

4. A method according to claim 1, wherein a metallic material of the body is aluminum, the long fibers being of silicon carbide.

5. A method according to claim 1, wherein the metallic material of the endpiece is aluminum, the short fibers being of silicon carbide.
